(19) United States
(12) Patent Application Publication
(10) Pub. No.: US 2012/0230588 A1
(43) Pub. Date: Sep. 13, 2012

(54) IMAGE PROCESSING DEVICE, IMAGE PROCESSING METHOD AND IMAGE PROCESSING PROGRAM

(75) Inventors: Shin Nakate, Yokosuka-shi (JP); Wataru Inoha, Miura-shi (JP); Ryota Niizeki, Yokohama-shi (JP)

(73) Assignee: JVC KENWOOD CORPORATION, Yokohama-shi, Kanagawa-ku (JP)

(21) Appl. No.: 13/509,214

(22) PCT Filed: Nov. 11, 2010
(86) PCT No.: PCT/JP2010/070114

§ 371 Date: May 10, 2012

(30) Foreign Application Priority Data
Nov. 13, 2009 (JP) P2009-259814
Sep. 30, 2010 (JP) P2010-221104

(51) Int. Cl. G06K 9/46

(52) U.S. Cl. 382/190

(57) ABSTRACT

An in-scene digest segment number determining unit allocates the total number of cuts to be extracted as digest segments to each scene of digest creation objective scenes. A feature quantity detecting unit selects a plurality of representative frames from respective frames included in a cut extraction scene where the number of digest segments to be extracted is one or more and further detects a feature quantity of each representative frame. An importance calculating unit calculates the degree of importance of each representative frame, based on the feature quantities of each representative frame. A digest segment selecting unit determines a digest segment to be selected from each cut extraction scene, based on both feature quantities and importance degrees of representative frames in each cut extraction scene.

### TECHNICAL FILED

The present invention relates to image processing devices, image processing methods and image processing program for creating an image data digest.

### BACKGROUND ART

In order for a user to find one that the user wants to look and listen from numerous image data stored in an equipment, searching of an objective image, for example, by means of playing pictures at fast speed would require a large amount of time and labor. Therefore there has been proposed a technique of creating an image data digest to facilitate user's searching of desired image data.

For instance, Patent Document No. 1 describes an image information recording and reproducing device which picks out a characteristic segment in accordance with a specific program genre (e.g. news, drama, music program, etc.), namely, an important segment for the program appropriately and creates a digest image for reproduction.

### PRIOR ART LITERATURES

### Patent Literatures

Patent Document No. 1: Japanese Patent No. 4039873

### SUMMARY OF THE INVENTION

### Problem to be Solved

In the technique described in Patent Document No. 1, however, if data parts regarded as the important segment get centered in a specific area of the whole pictures, e.g. early stage, only the stage would be reproduced in the form of a digest where the rest stage would not be reproduced at all. With such a digest, it is difficult for a user to grasp the contents of pictures as a whole.

Also, in Patent Document No. 1, there are described operations of: detecting a feature quantity with respect to each scene; evaluating the scene by the feature quantity; and selecting the scene as a whole or a predetermined segment in the scene, as the digest.

However, in this method, if selecting, as the digest, for instance, the entirety of a ten-minute scene containing only one-minute important segment as must-see sight, the remaining nine-minute part will become a scene having no special must-see sight. Alternatively, even when a part of this scene is selected for a digest, there is a possibility of selecting the digest from the remaining nine-minute part having no must-see sight.

Taking the above-mentioned situation into consideration, an object of the present invention is to provide an image processing device, an image processing method and an image processing program for creating a digest through which a user can grasp the contents of an overall image easily.

### Solution to the Problems

According to one aspect of the present invention, there is provided an image processing device comprising: an in-group digest segment number determining unit configured to determine the number of digest segments to be extracted from each of scenes forming image data; a feature quantity detecting unit configured to: select a plurality of representative frames out of frames included in a cut extraction scene where the number of digest segments determined by the in-group digest segment number determining unit is one or more; and detect at least one of: the number of faces of subjects existing in each of the representative frames; the position of a largest one of the faces in each of the representative frames; and the size of the largest face, as a feature quantity of each of the representative frames; a scene feature judging unit configured to judge a feature of the cut extraction scene, based on feature quantity; an importance calculating unit configured to calculate an importance degree of each of the representative frames, based on the feature quantity with use of calculating expression corresponding to the feature judged by the scene feature judging unit, the calculating expression being one of a plurality of predetermined calculating expressions corresponding to features of the cut extraction scene; a digest segment selecting unit configured to select cuts of the same number as the digest segments determined by the in-group digest segment number determining unit, from the cut extraction scene, based on the feature quantity and the importance degree; and a reproducing unit configured to reproduce the digest segments selected by the digest segment selecting unit.

According to another aspect of the present invention, there is also provided an image processing method comprising the steps of: determining the number of digest segments to be extracted from each of scenes forming image data; selecting a plurality of representative frames out of frames included in a cut extraction scene where the number of digest segments is one or more; and detecting at least one of: the number of faces of subjects existing in each of the representative frames; the position of a largest one of the faces in each of the representative frames; and the size of the largest face, as a feature quantity of each of the representative frames; judging a feature of the cut extraction scene, based on the feature quantity; calculating an importance degree of each of the representative frames, based on the feature quantity with use of a calculating expression corresponding to the feature judged by the scene feature judging unit, the calculating expression being one of a plurality of predetermined calculating expressions corresponding to features of the cut extraction scene; selecting cuts of the same number as the digest segments determined at the step of determining the number of digest segments, from the cut extraction scene, based on the feature quantity and the importance degree; and reproducing the digest segments selected at the step of selecting the digest segments.

According to the other aspect of the present invention, there is also provided an image processing program allowing an computer to execute the steps of: determining the number of digest segments to be extracted from each of scenes forming image data; selecting a plurality of representative frames out of frames included in a cut extraction scene where the number of digest segments is one or more; and detecting at least one of: the number of faces of subjects existing in each of the representative frames; the position of a largest one of the faces in each of the representative frames; and the size of the largest face, as a feature quantity of each of the representative frames; judging a feature of the cut extraction scene, based on the feature quantity; calculating an importance degree of each of the representative frames, based on the feature quantity with use of a calculating expression corresponding to the feature judged by the scene feature judging unit, the calculating expression being one of a plurality of predetermined calculating expressions corresponding to features of the cut extraction scene; selecting cuts of the same number as the digest segments determined at the step of determining the number of digest segments, from the cut extraction scene, based on the feature quantity and the importance degree; and reproducing the digest segments selected at the step of selecting the digest segments.

### EFFECTS OF THE INVENTION

According to the present invention, it is possible to create a digest which is easy for a user to grasp the contents of an overall image.

### BRIEF DESCRIPTION OF THE DRAWINGS

FIG. 1 is a block diagram showing the constitution of an image processing device in accordance with an embodiment of the present invention.

FIG. 2 is a flow chart showing the procedure of determining the number of cuts for allocating them to respective scenes.

FIG. 3 is a view showing an example of grouping.

FIG. 4 is an exemplary view showing an example of frame constitution of a cut extraction scene.

FIG. 5 is a view to explain feature quantities of a representative frame.

FIG. 6 is a view to explain an example of feature quantities of respective representative frames in the cut extraction scene.

FIG. 7 is a view to explain an example of importance degrees of respective representative frames in the cut extraction scene.

FIG. 8 is a view to explain another example of importance degrees of respective representative frames in the cut extraction scene.

FIG. 9 is a flow chart showing the procedure of determining digest segments.

FIG. 10 is an exemplary view showing digest segments.

### EMBODIMENTS OF THE INVENTION

There will be described embodiments of the present invention with reference to drawings.

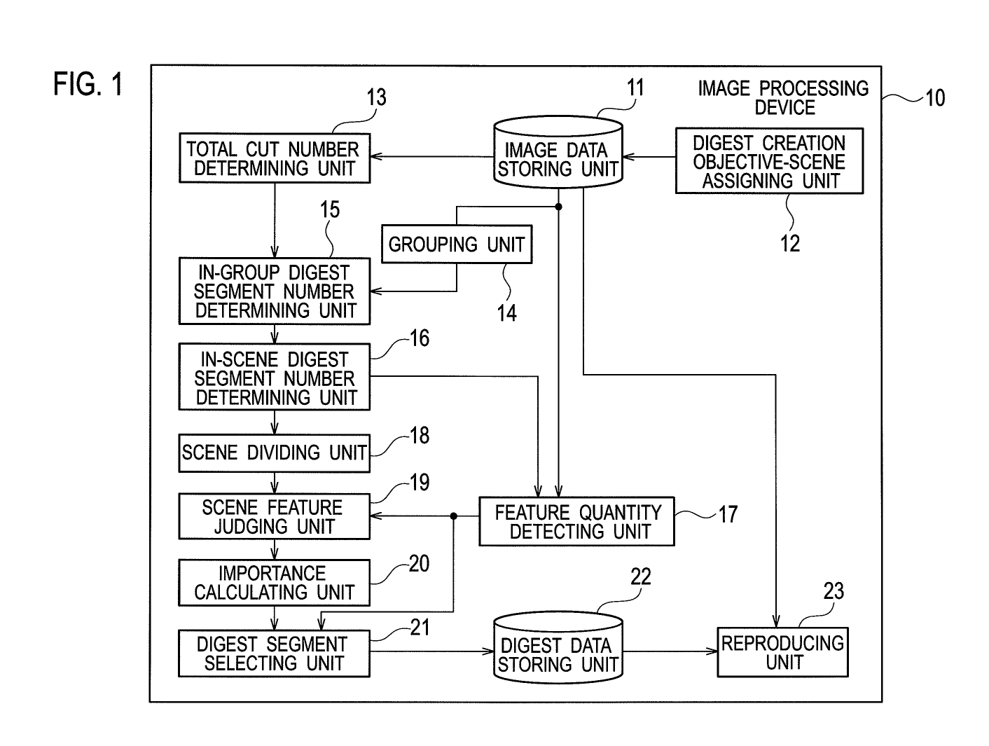

FIG. 1 is a block diagram showing the constitution of an image processing device in accordance with the embodiment of the present invention. In FIG. 1, the image processing device 10 includes an image data storing unit 11, a “digest creation” objective-scene assigning unit 12, a total cut number determining unit 13, a grouping unit 14, an in-group digest segment number determining unit 15, an in-scene digest segment number determining unit 16, a feature quantity detecting unit 17, a scene dividing unit 18, a scene feature judging unit 19, an importance calculating unit 20, a digest segment selecting unit 21, a digest data storing unit 22 and a reproducing unit 23.

The image data storing unit 11 includes a nonvolatile memory medium, such as hard disc and semiconductor memory medium, and stores image data recorded by a video camera or the like. The image data storing unit 11 is constructed so as to be detachable from the image processing device 10.

The image data stored in the image data storing unit 11 is accompanied with filming information containing a filming start time, a filming ending time, a filming location, etc. for each scene in the image data taken by a filming equipment, such as video camera. The filming information can be taken out from the filming equipment when taking pictures. Note here that in a series of filming operation, a scene is defined as a segment from its filming start till the filming end.

The “digest creation” objective-scene assigning unit 12 assigns an objective scene for digest creation out of scenes stored in the image data storing unit 11. This “digest creation” objective-scene may be assigned one by one, corresponding to a user's operation of an operation input unit (not shown) or all scenes taken between two scenes selected by a user's operation may be assigned as the “digest creation” objective-scene. Alternatively, upon assignment of a specific date corresponding to a user's operation, all scenes taken on the assigned date may be assigned as the “digest creation” objective-scene.

The total cut number determining unit 13 determines a total cut number Ac, which is the number of cuts forming a segment (digest segment) to be reproduced as “digest”, from the whole “digest creation” objective-scenes assigned by the “digest creation” objective-scene assigning unit 12.

The total cut number Ac may be assigned by a user's operation. Assuming that a user assigns a digest span, alternatively, the total cut number Ac may be determined corresponding to a value of the digest span.

Thus, when determining the total cut number Ac from the digest span, the total cut number determining unit 13 establishes a period as a target for an average cut time in advance and also calculates the total cut number Ac based on the previously-established period.

For instance, if the target for an average cut time is set to 10 seconds and a user assigns the digest span of 180 seconds, then the total cut cumber Ac will be 18 cuts because Ac=180÷10=18.

In connection with the calculating of a total cut number Ac from the digest span, it may be automatically calculated from information, such as a total filming time of the “digest creation” objective-scenes, instead of a user's operative inputting of the digest span.

The grouping unit 14 executes grouping of scenes in the objective scenes for digest creation, based on filming intervals between scenes, filming contents, etc. For instance, the grouping is executed with use of a method described in Japanese Patent Publication Laid-open No. 2009-99120. Consequently, there could be executed a grouping of collecting scenes closely related to each other in terms of filming time or location or another grouping of collecting scenes similar in their contents to each other.

The in-group digest segment number determining unit 15 allocates the total cut number Ac determined by the total cut number determining unit 13 to respective groups and also determines the number of cuts extracted from each group.

The in-scene digest segment number determining unit 16 allocates the cut number for each group determined by the in-group digest segment number determining unit 15 to respective scenes in the group and also determines the cut number selected from each scene.

The feature quantity detecting unit 17 selects a plurality of representative frames from the frames contained in a cut extraction scene having one or more cuts allocated by the in-scene digest segment number determining unit 16 and further detects feature quantities of each representative frame. For instance, the feature quantity detecting unit 17 detects the number of faces of subjects present in each representative frame, the position of the largest face in each representative frame and also its size, as the feature quantities of the representative frames.

The scene dividing unit 18 divides a cut extraction scene having two or more cuts allocated therein the same number of segmentation scenes as the number of allocated cuts. Thus, the scene dividing unit 18 divides a cut extraction scene equally by the number of cuts allocated therein so that one minute of scene having two cuts allocated therein is divided into two segmentation scenes composed of 30 seconds of scene on the front side and 30 seconds of scene on the rear side, for example.

The scene feature judging unit 19 distinguishes the feature of a scene with respect to each cut extraction scene by the feature quantities of representative frames and so on. For the cut extraction scene to be divided by the scene dividing unit 18, the above unit 19 distinguishes the feature of a scene with respect to each segmentation scene.

For instance, the scene feature judging unit 19 determines, as the feature of a scene, whether it contains a single subject or multiple subjects, based on the number of subject's faces detected by the feature quantity detecting unit 17.

The importance calculating unit 20 calculates the degree of importance of each representative frame, based on the feature quantities of each representative frame. The importance calculating unit 20 stores an importance calculating method with respect to each feature of the scene and therefore calculates the degree of importance of each representative frame from the feature quantities of each representative frame by the importance calculating method corresponding to the features of a cut extraction scene (e.g. for each segmentation scene in the above dividing case) determined by the scene feature judging unit 19.

The digest segment selecting unit 21 determines a segment to be selected as a cut (digest segment) for each cut extraction scene, based on the feature quantities of representative frames detected by the feature quantity detecting unit 17 and the degrees of importance of the representative frames calculated by the importance calculating unit 20.

The digest data storing unit 22 comprises a nonvolatile memory media, such as hard disc, and stores the information about cuts selected by the digest segment selecting unit 21 as digest data, in temporal sequence. The digest data contains scene IDs for identifying a scene to extract a cut with respect to each cut, respective starting times and ending times for the cuts. The scene IDs may be either formed by values allocated to the scenes in the recording order respectively or represented by respective names of video-files recording the scenes. Alternatively, the image data storing unit 11 may serve as the operation of the digest data storing unit 22.

Based on the digest data stored in the digest data storing unit 22, the reproducing unit 23 executes a digest reproducing to reproduce the cuts (digest segments), which have been selected from the image data stored in the image data storing unit 11 by the digest segment selecting unit 21, in the temporal order and further allows a display unit (not shown) connected to the image processing device 10 to display a digest image.

Next, the operation of the image processing device 10 will be described.

When the operation to assign an objective scene for digest creation is carried out by a user, the “digest creation” objective-scene assigning unit 12 assigns a “digest creation” objective-scene out of scenes stored in the image data storing unit 11 in response to the user's operation. Also, the total cut number determining unit 13 determines a total cut number Ac selected as the digest segment from the whole digest creation objective scenes.

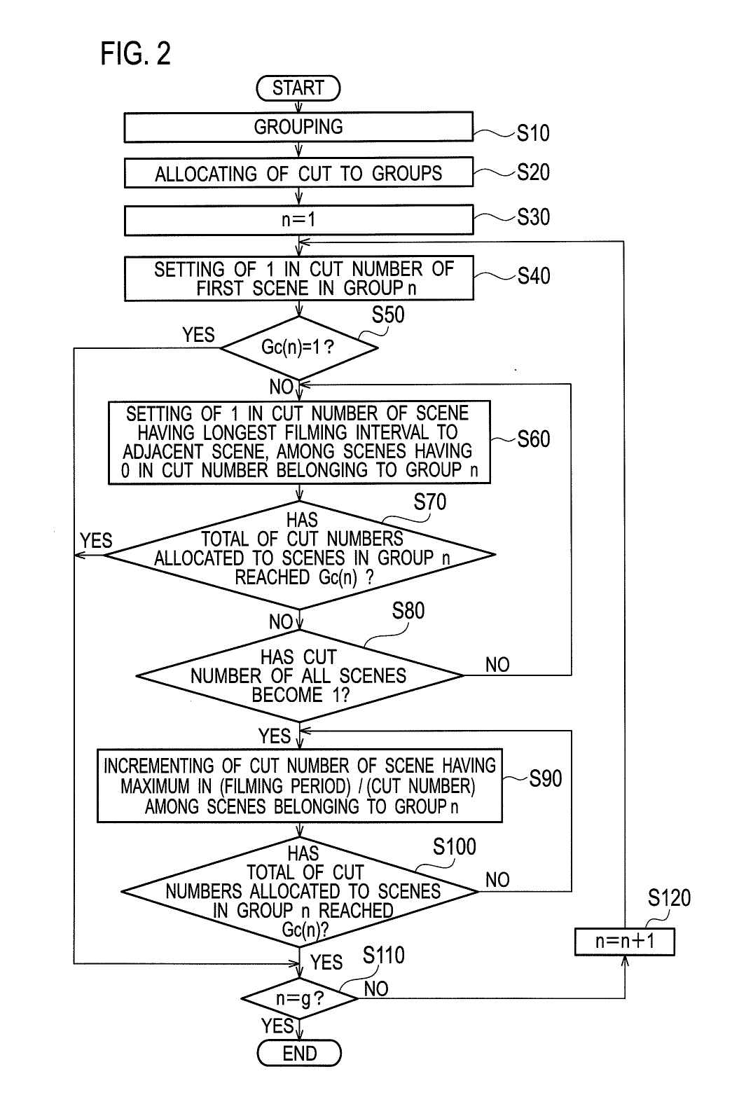

When the “digest creation” objective-scene is assigned and the total cut number Ac is determined, the image processing device 10 determines the number of cuts to be allocated to each scene in the digest creation objective-scene. This procedure will be described with reference to a flow chart of FIG. 2.

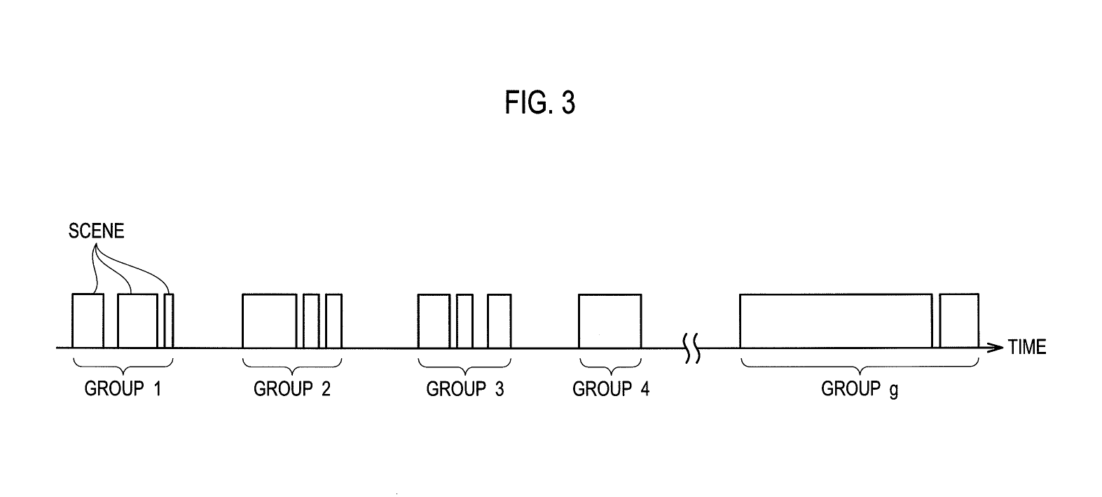

Firstly, at step S10, the grouping unit 14 executes grouping of respective scenes in the “digest creation” objective-scene. Assume in this embodiment that as shown in FIG. 3, the “digest creation” objective-scene is classified to “g” (number) groups from group 1 till group “g”.

Next, at step S20, the in-group digest segment number determining unit 15 allocates the total cut number Ac to respective groups and also determines the number of cuts to be extracted from each group. By allocating the cuts to respective groups classified based on a filming interval between scenes, filming contents, etc., it is possible to incorporate pictures in various scenes to a digest evenly across so that no disproportionate emphasis is placed on the scenes extracted as the digest.

According to the embodiment, the in-group digest segment number determining unit 15 calculates the number of cuts Gc(n) to be extracted from a group “n” (n=1, 2, . . . ) as

$$Gc ( n ) = \frac{log ( L ( n ) ) \times log ( N ( n ) + 1 )}{{\sum }_{i = 1}^{g} ( log ( L ( i ) \times log ( N ( i ) + 1 )} \times Ac . \qquad ( 1 )$$

Here L(n) denotes a total filming time of the group “n” and N(n) denotes the number of scenes contained in the group “n”.

By allocating cuts to respective groups through Eq. (1), it allows more cuts to be selected from a group where the number of scenes is greater and whose filming time is longer.

Then, at step S30, the in-scene digest segment number determining unit 16 sets a variable “n” representing the order of groups to 1.

Next, at step S40, the in-scene digest segment number determining unit 16 sets the number of cut in the first Scene of the group “n” to 1.

At next step S50, the in-scene digest segment number determining unit 16 judges whether the number of cuts Gc(n) allocated to the group “n” is equal to 1 or not. If Gc(n)=1 (“Yes” at step S50), then the routine goes to step S110. If Gc(n)≠1 (“No” at step S50), then the routine goes to step S60.

In the scenes belonging to the group “n”, at step S60, the in-scene digest segment number determining unit 16 sets 1 to the cut number of a scene whose filming interval to the immediately preceding scene is the longest in the scenes to which cuts have not been allocated yet (i.e. scenes having 0 in the number of cuts).

Next, at step S70, the in-scene digest segment number determining unit 16 judges whether the total number of cuts allocated to the scenes in the group “n” has reached Gc(n) or not. If reaching Gc(n) (“Yes” at step S70), then the routine goes to step S110. If not reaching Gc(n) yet (“No” at step 70), the routine goes to step S80.

At step S80, the in-scene digest segment number determining unit 16 judges whether the cut numbers of all scenes in the group “n” have become 1 respectively or not. If the cut numbers of all scenes become 1 (“Yes” at step S80), then the routine goes to step S90. While, if there exists a scene having the cut number of 0 (“No” at step S80), the routine returns to step S60.

At step S90, the in-scene digest segment number determining unit 16 increments the cut number of a scene having a maximum value of (filming period)/(cut number) among the scenes belonging to the group “n” by one.

At next step S100, the in-scene digest segment number determining unit 16 judges whether the total of respective cut numbers allocated to the scenes in the group “n” has reached Gc(n) or not. If it has reached Gc(n) (“Yes” at step S100), then the routine goes to step S110. While, if it has not reached Gc(n) yet (“No” at step S100), the routine returns to step S90.

At step S110, the in-scene digest segment number determining unit 16 judges whether the variable “n” is a value “g” that represents the last group or not. If n=g (“Yes” at step S110), then the operation is finished. If n≠g (“No” at step S110), then the routine goes to step S120 where the in-scene digest segment number determining unit 16 increments the variable “n” by one and thereafter, the routine returns to step S40.

With the above process, the allocation of cuts to respective scenes in the group is accomplished for all of the groups 1 to “g”.

It is noted that the method of allocating cuts to respective scenes is not limited to only the above-mentioned process. For instance, the number of cuts for each scene may be assigned by a user.

In each group, alternatively, cuts may be allocated to respective scenes, one by one in the order of filming period from longest to shortest. In this case, if the total cut number Ac is more than the number of scenes, it becomes possible to select multiple scenes from a long scene since the remained cuts are again allocated to scenes one by one in the order of filming period from longest to shortest.

Further, cuts may be allocated to respective scenes on the basis of a filming interval between adjacent scenes. For instance, it is executed to first calculate respective filming intervals each between the adjacent scenes and subsequently allocate cuts to respective scenes in each group in the order of a filming interval between one scene and its immediately-preceding scene from longest to shortest.

Still further, the above-mentioned methods may be combined with the grouping of scenes depending on their filming contents in allocating the cuts to the scenes.

Here, a scene having one or more cuts (digest segment) allocated by the in-scene digest segment number determining unit 16 will be referred to as “cut extraction scene” after. The feature quantity detecting unit 17 selects representative frames out of respective frames included in one cut extraction scene, at predetermined intervals and further detects the feature quantities representing the feature of respective representative frames selected.

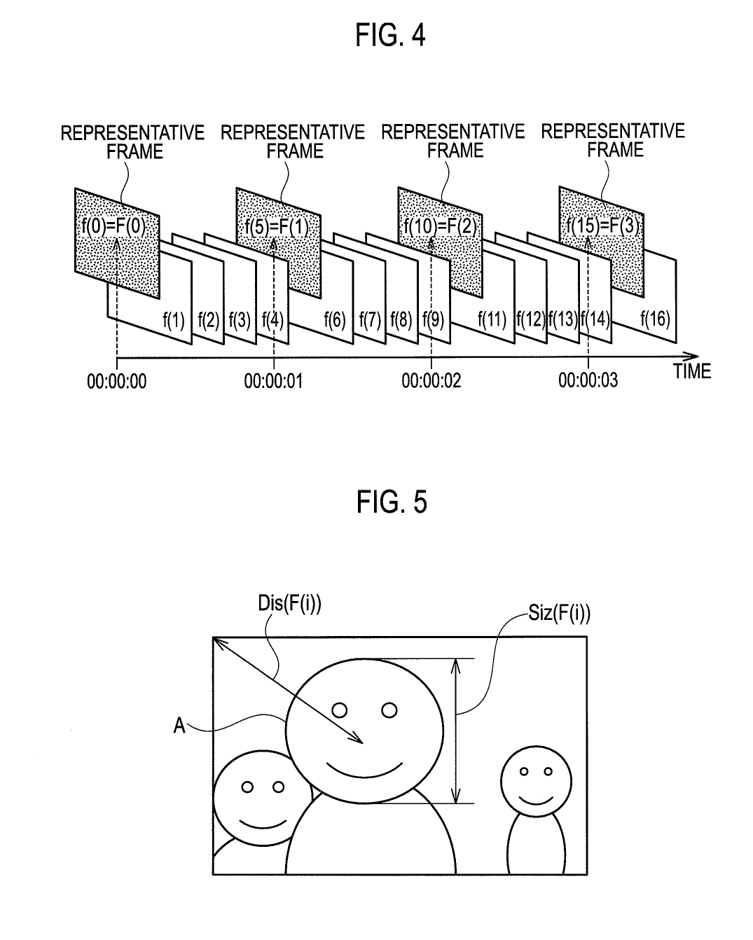

Assume that, for example, there is provided a cut extraction scene comprising 17 frames composed of a frame f(0) to a frame f(16), as shown in FIG. 4. In FIG. 4, a horizontal axis designates recording time for respective frames.

In case of selecting frames as the representative frames, for instance, every one second, the feature quantity detecting unit 17 establishes four frames: a leading frame f(0); a frame f(5) recorded when one second has passed since the start of filming; a frame f(10) recorded when one second has passed since the frame f(5); and a frame f(15) recorded when one second has passed since the frame f(10), as respective representative frames F(0), F(1), F(2) and F(3) and also detects feature quantities from them.

According to the embodiment, the feature quantity detecting unit 17 detects, as the feature quantities of one representative frame f(i), the number of faces Num(F(i)) of subjects present in the representative frame F(i) (i=0, 1, 2, . . . ), a distance Dis(F(i)) from a center of the largest face to one of four corners forming the frame, which is closest to the center of the largest face, and a size of the largest face Siz(F(i)).

Various methods are known to detect an image of a face. As the image of a face can be detected by means of a technique disclosed in, for instance, Japanese Patent Publication No. 4158153, the descriptions about processing contents will be eliminated.

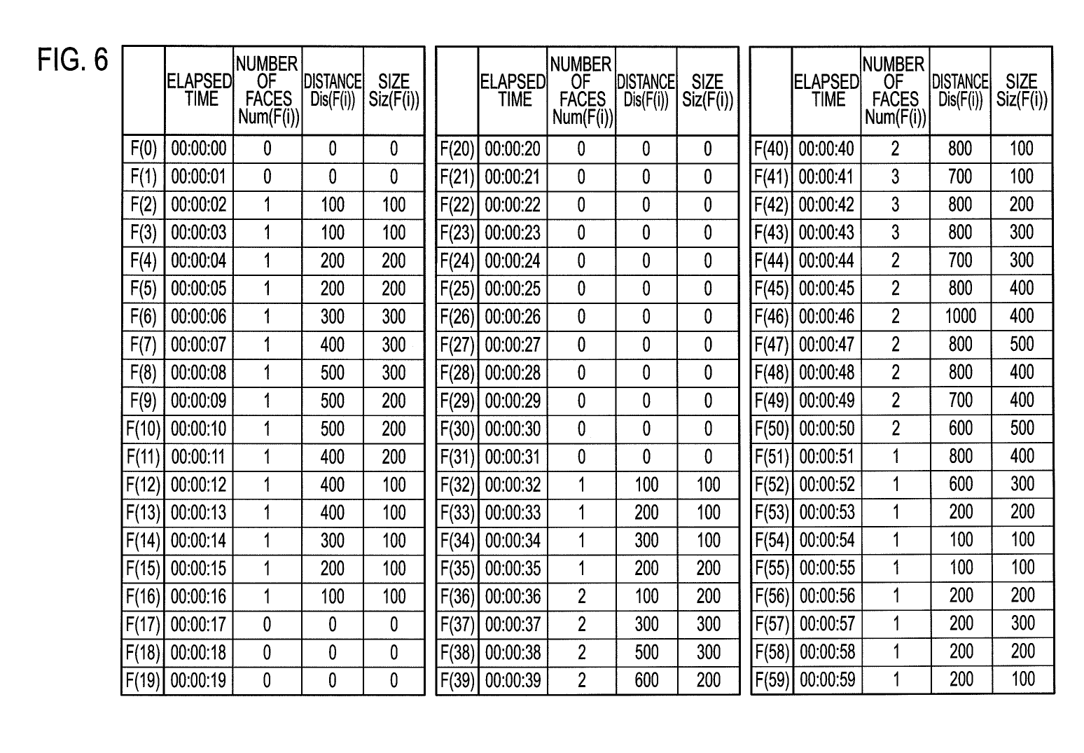

One example of a frame including subjects' faces is shown in FIG. 5. In the frame of FIG. 5, the largest one of faces in a picture is indicated with alphabet A. In addition, as the closest one of four corners to the center of the face A is a top-left corner, a distance from the center of the face A to the top-left corner of the frame is represented by Dis(F(i)). Siz(F(i)) designates a vertical length of the largest face A. As the frame of FIG. 5 contains three faces in a picture, the value of Num(F(i)) will become 3 (i.e. Num(F(i))=3).

These feature quantities may be obtained by reading those acquired by a filming equipment at filming and successively stored in files etc. Alternatively, they may be acquired by the feature quantity detecting unit 17 analyzing image data.

If there is a cut extraction scene having two or more cuts allocated by the in-scene digest segment number determining unit 16, then the scene dividing unit 18 divides the cut extraction scene into segmentation scenes of the same number as the number of allocated cuts.

Next, the scene feature judging unit 19 judges the feature of a scene with respect to each cut extraction scene. For the cut extraction scene divided by the scene dividing unit 18, the above unit judges the scene feature with respect to each segmentation scene. In this embodiment, the scene feature judging unit 19 judges, as the scene feature, whether the subject is a single or multiple, based on the number of subjects' faces Num(F(i)) in the representative frame F(i) detected by the feature quantity detecting unit 17.

For each cut extraction scene (note: each segmentation scene in case of dividing a cut extraction scene), the scene feature judging unit 19 judges whether the number of subjects' faces in each representative frame within the relevant scene is 1 or 2 or more and further counts the number of representative frames each having a single face and the number of representative frames each having two or more faces.

Then, if the number of representative frame each having a single face is more than the number of representative frame each having two or more faces, it is judged that the subject of that scene is single. On the other hand, if the number of representative frames each having two or more face is more than the number of representative frame each having a single face, it is judged that the subject of that scene is multiple. In connection, if no face is detected throughout the representative frames, then it is established that the subject of that scene is single.

FIG. 6 shows a lapse time since the start of scene and respective feature quantities (Num(F(i)), Dis(F(i)), Siz(F(i))) of each representative frame in a one-minute cut extraction scene. Taking the scene of FIG. 6 as an example, the judgment of scene feature by the scene feature judging unit 19 will be described in respective cases that the number of cuts allocated to the cut extraction scene is 1 and 2.

### (1) Case of Cut Number “1” Allocated to Cut Extraction Scene

Judge the scene feature from all the representative frames in the cut extraction scene.

From FIG. 6, it will be found that the number of representative frames each having a single face is 28 in all the representative frames, while the number of representative frames each having two or more faces is 15. Thus, as the representative frames each having a single face is more than the representative frames each having two or more faces, this scene is characterized in that “the subject is single”.

### (2) Case of Cut Number “2” Allocated to Cut Extraction Scene

Divide the cut extraction scene into two segmentation scenes of: 00:00:00˜00:00:29; and 00:00:30˜00:00:59 and Judge features of respective segmentation scenes.

In the segmentation scene from 00:00:00 to 00:00:29 (1^{st}. segmentation scene), although there are 15 frames in the number of representative frames each having a single face, there is no frame having two or more faces. Thus, the first segmentation scene is characterized in that “the subject is single”.

In the segmentation scene from 00:00:30 to 00:00:59 (2^{nd}. segmentation scene), there are 13 frames in the number of representative frames each having a single face, while there are 15 frames in the number of representative frames each having two or more faces. Thus, as the frames each having two or more faces are more than the frames each having a single face, the second segmentation scene is characterized in that “the subject is multiple”.

When the feature of each cut extraction scene is determined by the scene feature judging unit 19, the importance calculating unit 20 calculates the degrees of importance of respective representative frames from their feature quantities corresponding to the feature of that scene.

In calculating the degree of importance, the importance calculating unit 20 firstly obtains respective maximums MaxNum, MaxDis and MaxSiz of Num(F(i)), Dis(F(i)) and Siz(F(i)) in the cut extraction scene. For the cut extraction scenes divided by the scene dividing unit 18, these values are obtained with respect to each segmentation scene.

Utilizing the above values, the importance calculating unit 20 calculates the importance degree I(F(i)) of the representative frame F(i) included in the scene characterized by “subject is single” as Eq. (2):

I(F(i))=10Siz(F(i))/MaxSiz+Dis(F(i))/MaxDis. (2)

Also, the importance calculating unit 20 calculates the importance degree I(F(i)) of the representative frame F(i) included in the scene characterized by “subject is multiple” as Eq. (3):

I(F(i))=100Num(F(i))/MaxNum+10Dis(F(i))/MaxDis+Siz(F(i))/MaxSiz. (3)

Hereat, taking the scene of FIG. 6 as an example, the calculating of the importance degree I(F(i)) will be described in respective cases that the number of cuts allocated to the cut extraction scene is 1 and 2.

### (1) Case of Cut Number “1” Allocated to Cut Extraction Scene

In this case, as respective maximums of Num(F(i)), Dis(F(i)) and Siz(F(i)) are obtained from the whole scene, the result is as follows:

MaxNum=3; MaxDis=1000; and MaxSiz=500.

Then, by substituting these values into Eq. (2), the importance degree of each representative frame is calculated as Eq. (4):

I(F(i))=10Siz(F(i))/500+Dis(F(i))/1000. (4)

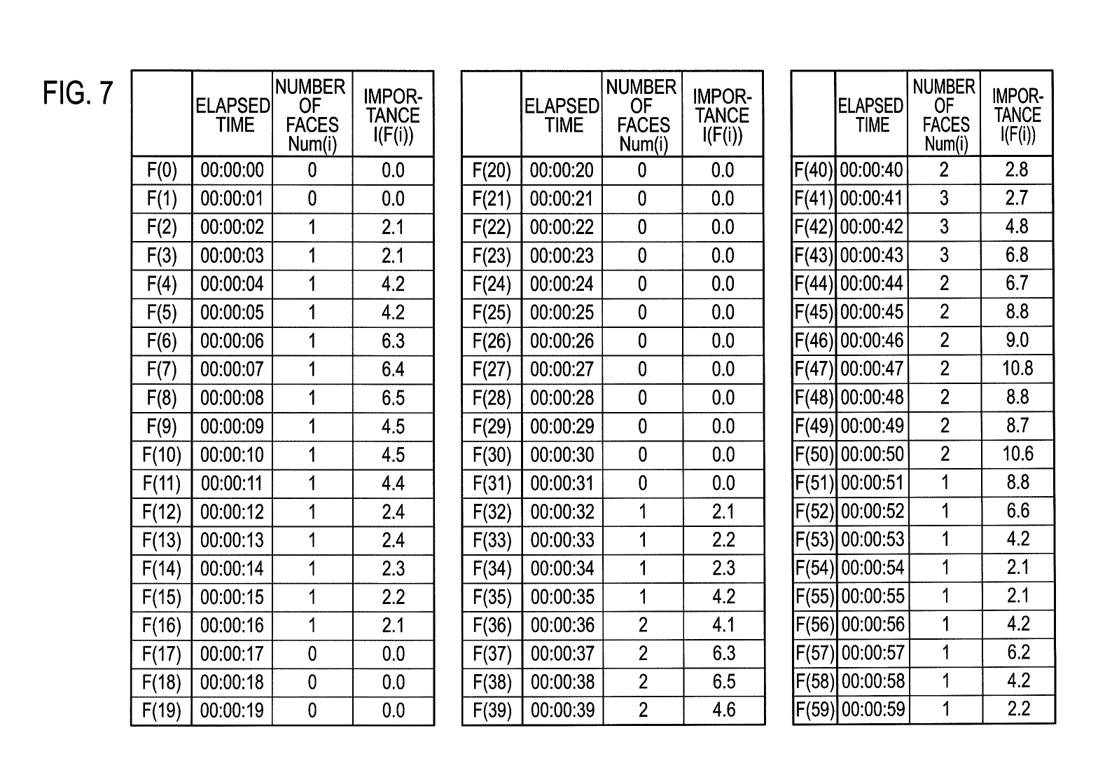

The above-calculated degree of importance I(F(i)) is shown with a table of FIG. 7.

### (2) Case of Cut Number “2” Allocated to Cut Extraction Scene

In this case, respective maximums of the feature quantities are obtained with respect to each segmentation scene, and the degrees of importance I(F(i)) of respective representative frames F(i) are calculated.

First, the degree of importance I(F(i)) of each representative frame F(i) is calculated for the first segmentation scene (00:00:00˜00:00:29)

From FIG. 6, it is found that the maximums of respective feature quantities in the first segmentation scene are as follows:

MaxNum=1; MaxDis=500; and MaxSiz=300.

As mentioned before, as the scene feature judging unit 19 judges that the first segmentation scene is characterized by “subject is single”, the degree of importance I(F(i)) is calculated by substituting the above maximums into Eq. (2) as below:

I(F(i))=10 Siz(F(i))/300+Dis(F(i))/500. (5)

Next, calculate the degree of importance I(F(i)) of each representative frame F(i) for the first segmentation scene (00:00:30˜00:00:59)

From FIG. 6, it is found that the maximums of respective feature quantities in the second segmentation scene are as follows:

MaxNum=3; MaxDis=1000; and MaxSiz=500.

As mentioned before, as the scene feature judging unit 19 judges that the second segmentation scene is characterized by “subject is multiple”, the degree of importance I(F(i)) is calculated by substituting the above maximums into Eq. (3) as below:

I(F(i))=100Num(F(i))/3+10Dis(F(i))/1000+Siz(F(i))/500. (6)

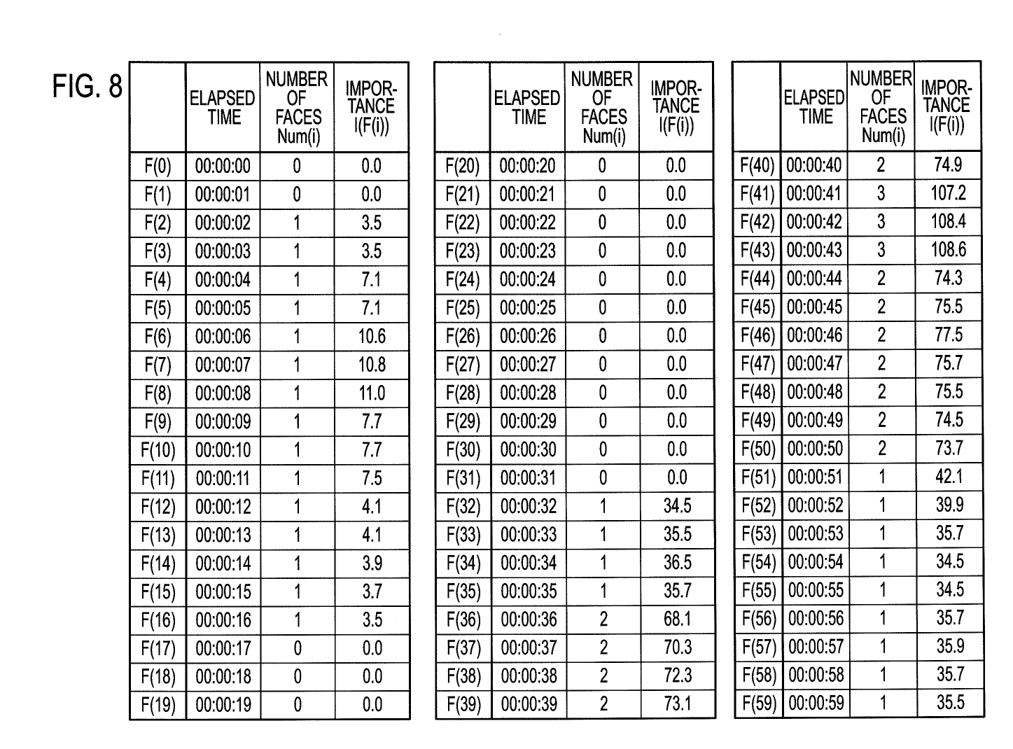

The above-calculated degree of importance I(F(i)) is shown with a table of FIG. 8.

According to the above-mentioned method of calculating the importance degree, the importance degree gets increased in a scene portion where a subject is zoomed greatly, in the scene where the subject is single, while the importance degree gets increased in a scene portion where many persons are present, in the scene where the subject is formed by multiple persons. Consequently, for the scene where the subject is single, it is possible to allow a scene portion where the subject is zoomed greatly to incorporated to a digest. For the scene where the subject is formed by multiple persons, it is possible to allow a scene portion where more persons are present to be incorporated to a digest.

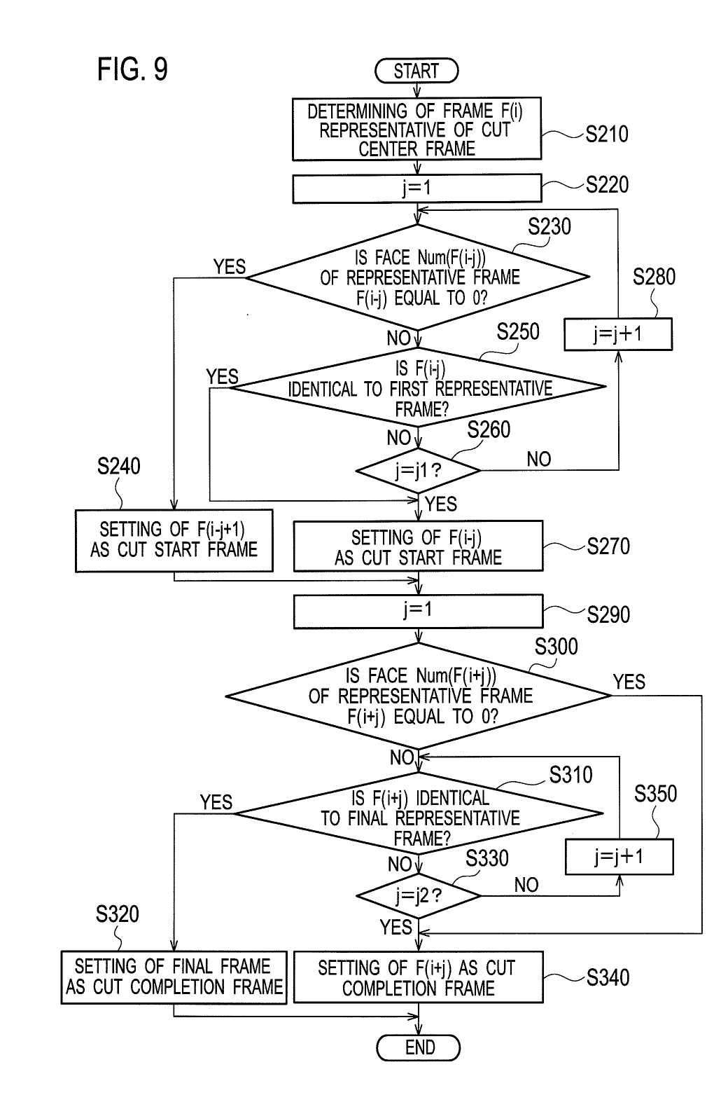

By using the importance degrees of respective representative frames calculated by the importance calculating unit 20 and also the feature quantities of respective representative frames detected by the feature quantity detecting unit 17, the digest segment selecting unit 21 determines a cut segment to be selected as the digest segment with respect to each cut extraction scene. This procedure will be described with reference to a flow chart of FIG. 9.

First, at step S210, the digest segment selecting unit 21 determines a cut center frame as a reference of determining the cut segment. Here, the digest segment selecting unit 21 selects, as the center frame, a representative frame having the highest importance degree from all the representative frames within the cut extraction scene.

At next step S220, the digest segment selecting unit 21 sets the variable j to “1”.

Next, at step S230, the digest segment selecting unit 21 further judges whether the number of faces Num(F(i)) as one of the feature quantities in a representative frame F(i−j), which lies anterior to the representative frame F(i) selected as the cut center frame by j sheets in time series, is equal to “0” or not. If the face number Num(F(i))=0 (“Yes” at step S230), then the routine goes to step S240. While, if the face number Num(F(i))≠0 (“No” at step S230), then the routine goes to step S250.

At step S240, the digest segment selecting unit 21 establishes the representative frame F(i−j+1) as the cut start frame which is the first frame of a cut selected as the digest segment. Subsequently, the routine goes to step S290.

At step S250, the digest segment selecting unit 21 judges whether the representative frame F(i−j) is the first representative frame in the cut extraction scene or not. If it is the first representative frame (“Yes” at step S250), the routine goes to step S270. If the representative frame F(i−j) is not the first representative frame (“No” at step S250), the routine goes to step S260.

At step S260, the digest segment selecting unit 21 judges whether the variable “j” is identical to a first predetermined value j1 or not. If j=j1 (“Yes” at step S260), then the routine goes to step S270. If j≠j1 (“No” at step S260), then the routine goes to step S280 where the digest segment selecting unit 21 increments the variable j by one and subsequently, the routine returns to step S230.

At step S270, the digest segment selecting unit 21 establishes the representative frame F(i−j) as the cut start frame.

With the process so far, after retracing the cut center frame to a previous representative frame in time-series by the first predetermined value j1 at maximum, the digest segment selecting unit 21 sequentially judges the number of faces in each representative frame and also determines a representative frame, which is positioned behind by one piece from the firstly-detected representative frame having “0” in the number of faces, as the cut start frame. If all the representative frames extending from the cut center frame up to a previous representative frame by the first predetermined value j1 have one or more faces each, the same unit 21 also determines a representative frame, which is positioned in front of the cut center frame by the first determined value j1, as the cut start frame. In addition, if retracing up to the first representative frame before the representative frame having “0” in the number of faces is detected, then the first representative frame is established as the cut start frame.

On determination of the cut start frame, at step S290, the digest segment selecting unit 21 sets the variable “j” to “1” to determine a cut completion frame to be the last frame in a cut selected as the digest segment.

Next, at step S300, the digest segment selecting unit 21 judges whether the face number Num(F(i+j)) in a representative frame F(i+j), which is being behind the representative frame F(i) selected as the cut center frame, is “0” or not. If Num(F(i+j))=0 (“Yes” at step S300), then the routine goes to step S340. While, if Num(F(i+j))≠0 (“No” at step S300), then the routine goes to step S310.

At step S310, the digest segment selecting unit 21 judges whether the representative frame F(i+j) is a final representative frame in the cut extraction scene or not. If the representative frame F(i+j1) is the final representative frame (“Yes” at step S310), then the routine goes to step S320. While, if the representative frame F(i+j1) is not the final representative frame (“No” at step S310), the routine goes to step S330.

At step S320, the digest segment selecting unit 21 establishes the final frame as the cut completion frame.

At step S330, the digest segment selecting unit 21 judges whether the variable j is identical to a second predetermined value J2 or not. If j=j2 (“Yes” at step S330), the routine goes to step S340. If j≠j2 (“No” at step S330), the routine goes to step S350 where the digest segment selecting unit 21 increments the variable “j” by one and subsequently, the routine returns to step S310.

At step S340, the digest segment selecting unit 21 establishes the representative frame F(i+j) as the cut completion frame.

With the process after step S290, the digest segment selecting unit 21 sequentially judges the number of faces in each representative frame in a range from the cut center frame up to a representative frame subsequent in time-series by the second predetermined value j2 at maximum, and also determines a firstly-detected representative frame having “0” in the number of faces, as the cut completion frame. If all the representative frames extending from the cut center frame up to the subsequent representative frame by the second predetermined value j2 have one or more faces each, the same unit 21 also determines a representative frame, which is positioned behind the cut center frame by the second determined value j2, as the cut completion frame. In addition, if no representative frame having “0” in the number of faces has been detected until the final representative frame, then a final frame in the cut extraction scene is established as the cut start frame.

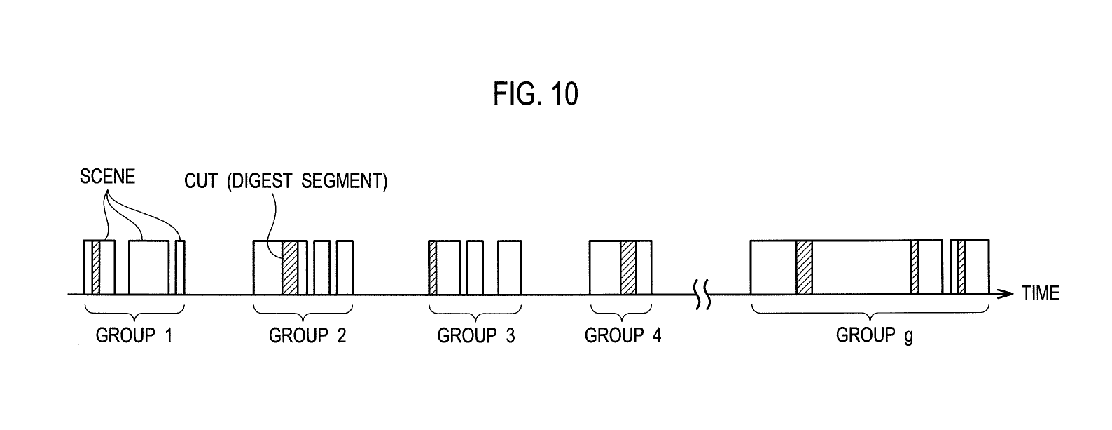

With the above process, the digest segment is determined from the digest creation objective-scene, for example, as shown in FIG. 10. The digest segment is formed by a segment containing the representative frames up to (j1+j2+1) pieces including a representative frame (cut center frame) having the highest importance degree in each cut extraction scene. For the cut extraction scenes divided by the scene dividing unit 18, the digest segment is determined with respect to each segmentation scene, in accordance with the operation of the above-mentioned flow chart of FIG. 9.

Taking the scene of FIG. 6 as an example, specific examples in determining the digest segment will be provided in respective cases that the number of cuts allocated to the cut extraction scene is 1 and 2. Assume here that j1=5 and j2=15.

(1) Case of Cut Number “1” Allocated to Cut Extraction Scene

From the table of FIG. 7, it is found that the importance degree is maximized in the representative frame F(47). Thus, the representative frame F(47) is established as the cut center frame.

In succession, the cut start frame is determined. As the number of faces is always “1” or more in the range from the cut center frame F(47) till the preceding representative frame F(42) by 5 seconds (=j1) from the table of FIG. 7, the representative frame F(42) before the cut center frame by 5 seconds is established as the cut start frame.

Next, the cut completion frame is determined As the number of faces is “1” or more in the range from the cut center frame F(47) till the last representative frame

F(59) from the table of FIG. 7, the final frame in the scene is established as the cut completion frame.

From above, the digest segment to be extracted from the scene of FIG. 6 becomes a range from the representative frame F(42) till the end of the scene, that is, a segment from 00:00:42 to the completion of scene.

(2) Case of Cut Number “2” Allocated to Cut Extraction Scene

First of all, the digest segment is determined for the first segmentation scene (00:00:00˜00:00:29). From the table of FIG. 8, it is found that the importance degree is maximized in the representative frame F(8) in the first segmentation scene. Thus, the representative frame F(8) is established as the cut center frame.

In succession, the cut start frame is determined. As the number of faces is always “1” or more in the range from the cut center frame F(8) till the preceding representative frame F(3) by 5 seconds from the table of FIG. 8, the representative frame F(3) before the cut center frame F(8) by 5 seconds is established as the cut start frame.

Next, the cut completion frame is determined. The number of faces is “1” or more in the range from the cut center frame F(8) till the subsequent representative frame F(16) by 8 seconds from the table of FIG. 8. Nevertheless, as the representative frame F(17) after a lapse of 9 seconds has “0” in the number of faces, the same representative frame F(17) is established as the cut completion frame.

Therefore, the digest segment to be extracted from the first segmentation scene becomes a range from the representative frame F(3) till the representative frame F(17), that is, a segment from 00:00:03 to 00:00:17.

Similarly, the digest segment is determined for the second segmentation scene. From the table of FIG. 8, it is found that the importance degree is maximized in the representative frame F(43) in the second segmentation scene. Thus, the representative frame F(43) is established as the cut center frame.

In succession, the cut start frame is determined. As the number of faces is always “1” or more in the range from the cut center frame F(43) till the preceding representative frame F(38) by 5 seconds from the table of FIG. 8, the representative frame F(38) before the cut center frame F(43) by 5 seconds is established as the cut start frame.

Next, the cut completion frame is determined. As the number of faces is “1” or more in the range from the cut center frame F(43) till the subsequent representative frame F(58) by 15 (=j2) seconds from the table of FIG. 8, the representative frame F(58) after the cut center frame F(43) by 15 seconds since is established as the cut completion frame.

Therefore, the digest segment to be extracted from the second segmentation scene becomes a range from the representative frame F(38) till the representative frame F(58), that is, a segment from 00:00:38 to 00:00:58.

From above, two segments composed of one segment from 00:00:03 to 00:00:17 and another segment from 00:00:38 to 00:00:58 are extracted as the digest segments, from the scene of FIG. 6.

The digest segment selecting unit 21 stores the above-selected cut information as the digest data in the digest data storing unit 22, in time series.

Then, based on the digest data stored in the digest data storing unit 22, the reproducing unit 23 reproduces the digest segments from the image data stored in the image data storing unit 11 in time series, allowing a display unit (not shown) to display digest images.

According to the embodiment, as mentioned above, it is executed to allocate the total number of cuts Ac to be extracted as digest segments to each scene of digest creation objective scenes and further determine a digest segment to be selected from each cut extraction scene, based on both feature quantities and importance degrees of representative frames in each cut extraction scene. Thus, as the digest segments, it is possible to select unbiased important parts from the whole digest creation objective scenes, allowing creation of a digest easy for a user to grasp the contents of pictures of the whole digest creation objective scenes.

In addition, as the features of a cut extraction scene are judged and the importance degrees of representative frames are calculated with use of an importance calculating method defined with respect to each feature, it is possible to extract a part eligible for the digest segment, corresponding to the features of each cut extraction scene.

In connection with the feature quantities, the device may be constructed so as to detect at least one of the number of subject faces existing in each representative frame, the position of a largest face in each representative frame and the size of the largest face. Again, without being limited to the above method only, the calculating method of importance degree may be adapted so as to calculate the importance degree by at least one feature quantity of the number of subject faces existing in each representative frame, the position of a largest face in each representative frame and the size of the largest face.

In case of selecting two or more digest segments from one cut extraction scene, by dividing the cut extraction scene into respective segmentation scenes, judging the features with respect to each segmentation scene and determining a digest segment corresponding to the feature of each segmentation scenes, it is possible to create a digest reflecting the features of respective scenes evenly across.

In lieu of executing the grouping of the digest creation objective scene in the grouping unit 14 and the in-group digest segment number determining unit 15, the in-scene digest segment number determining unit 16 may have charge of allocate the total number of cuts Ac to each scene of the digest creation objective scenes while eliminating the grouping unit 14 and the in-group digest segment number determining unit 15.

Alternatively, there may be employed color information or brightness, motion vector, voice information, etc. for the feature quantities of representative frames detected by the feature quantity detecting unit 17.

For the feature of a scene to be judged by the scene feature judging unit 19, additionally, there may be adopted other features, for example, whether the filming day time of a scene was AM or PM; whether the filming time period of a scene is longer than a predetermined period or not, whether the background is indoor or outdoor, whether a human voice has been recorded or not, whether the scene is accompanied with applause, whether the audio level is more than a fixed threshold level or not, etc. so that the importance calculating unit 20 may use the importance calculating methods corresponding to these features.

The image processing device 10 of the embodiment may be constructed, in part or its entirety, by a personal computer or the like. Then, the above-mentioned functions of respective units forming the device could be implemented by computer's hardware or software. For instance, a program that allows a computer to execute part or all of the operations described in the above embodiment may be stored in computer's memory media, such as hard-disc and CD-ROM, for use in the computer. Alternatively, such a program may be down-loaded into a computer memory etc.

### INDUSTRIAL APPLICABILITY

As mentioned above, according to the present invention, it is possible to provide an image processing device which creates a digest easy for a user to grasp the contents of pictures as a whole.

### REFERENCE SIGNS

10 Image Processing Device

11 Image Data Storing Unit

12 Digest Creation Objective-Scene Assigning Unit

13 Total Cut Number Determining Unit

14 Grouping Unit

15 In-Group Digest Segment Number Determining Unit

16 In-Scene Digest Segment Number Determining Unit

17 Feature Quantity Detecting Unit

18 Scene Dividing Unit

19 Scene feature judging unit

20 Importance Calculating Unit

21 Digest Segment Selecting Unit

23 Reproducing Unit

1. An image processing device comprising:
an in-group digest segment number determining unit configured to determine the number of digest segments to be extracted from each of scenes forming image data;
a feature quantity detecting unit configured to:
select a plurality of representative frames out of frames included in a cut extraction scene where the number of digest segments determined by the in-group digest segment number determining unit is one or more; and
detect at least one of: the number of faces of subjects existing in each of the representative frames; the position of a largest one of the faces in each of the representative frames; and the size of the largest face, as a feature quantity of each of the representative frames;
a scene feature judging unit configured to judge a feature of the cut extraction scene, based on the feature quantity;
an importance calculating unit configured to calculate an importance degree of each of the representative frames based on the feature quantity with use of a calculating expression corresponding to the feature judged by the scene feature judging unit, the calculating expression being one of a plurality of predetermined calculating expressions corresponding to features of the cut extraction scene;
a digest segment selecting unit configured to select cuts of the same number as the digest segments determined by the in-group digest segment number determining unit, from the cut extraction scene, based on the feature quantity and the importance degree; and
a reproducing unit configured to reproduce the digest segments selected by the digest segment selecting unit.

2. The image processing device of claim 1, further comprising
a dividing unit configured to divide, of the cut extraction scenes, a cut extraction scene from which it is determined to extract two or more digest segments, into segmentation cut extraction scenes of the same number as the digest segments, wherein
the scene feature judging unit judges the feature of each of the segmentation cut extraction scenes from feature quantities of multiple representative frames included in each of the segmentation cut extraction scenes, and
the importance calculating unit uses, of the plurality of predetermined calculating expressions, a calculating expression corresponding to the feature of the segmentation cut extraction scene.

3. An image processing method comprising the steps of:
determining the number of digest segments to be extracted from each of scenes forming image data;
selecting a plurality of representative frames out of frames included in a cut extraction scene where the number of digest segments is one or more; and detecting at least one of: the number of faces of subjects existing in each of the representative frames; the position of a largest one of the faces in each of the representative frames; and the size of the largest face, as a feature quantity of each of the representative frames;
judging a feature of the cut extraction scene, based on the feature quantity;
calculating an importance degree of each of the representative frames based on the feature quantity with use of a calculating expression corresponding to the feature judged by the scene feature judging unit, the calculating expression being one of a plurality of predetermined calculating expressions corresponding to features of the cut extraction scene;
selecting cuts of the same number as the digest segments determined at the step of determining the number of digest segments, from the cut extraction scene, based on the feature quantity and the importance degree; and
reproducing the digest segments selected at the step of selecting the digest segments.

4. The image processing method of claim 3, further comprising the step of dividing, of the cut extraction scenes, a cut extraction scene from which it is determined to extract two or more digest segments, into segmentation cut extraction scenes of the same number as the digest segments, wherein
the cut extraction scene feature judging step comprises a step of judging the feature of each of the segmentation cut extraction scenes from feature quantities of multiple representative frames included in each of the segmentation cur extraction scenes divided at the dividing step, and
the importance degree calculating step comprises a step of using, of the plurality of predetermined calculating expressions, a calculating expression corresponding to the feature of the segmentation cut extraction scene.

5. A non-transitory computer readable medium storing an image processing program causing a computer to execute the steps of:
determining the number of digest segments to be extracted from each of scenes forming image data;
selecting a plurality of representative frames out of frames included in a cut extraction scene where the number of digest segments is one or more; and detecting at least one of: the number of faces of subjects existing in each of the representative frames; the position of a largest one of the faces in each of the representative frames;
and the size of the largest face, as a feature quantity of each of the representative frames;
judging a feature of the cut extraction scene, based on the feature quantity;
calculating an importance degree of each of the representative frames based on the feature quantity with use of a calculating expression corresponding to the feature judged by the scene feature judging unit, the calculating expression being one of a plurality of predetermined calculating expressions corresponding to features of the cut extraction scene;
selecting cuts of the same number as the digest segments determined at the step of determining the number of digest segments, from the cut extraction scene, based on the feature quantity and the importance degree; and
reproducing the digest segments selected at the step of selecting the digest segments.

6. The non-transitory computer readable medium of claim 5, wherein the image processing program further causes the computer to execute the step of dividing, of the cut extraction scenes, a cut extraction scene from which it is determined to extract two or more digest segments, into segmentation cut extraction scenes of the same number as the digest segments, wherein
the importance degree calculating step comprises a step of using, of the plurality of predetermined calculating expressions, a calculating expression corresponding to the feature of the segmentation cut extraction scene.
